(19) United States
(12) Patent Application Publication
(10) Pub. No.: US 2008/0191443 A1
(43) Pub. Date: Aug. 14, 2008

(54) Twist Beam Axle with Integral Torsion Bar

(75) Inventors: Gianfranco Gabbianelli, Troy, MI (US); P. Gregory Kiselis, Livonia, MI (US); Mark F. Werner, La Salle (CA); Seetarama S. Kotagiri, Woodside, CT (US); Darren A. Womack, Windsor (CA)

Correspondence Address: MAGNA INTERNATIONAL, INC., 337 MAGNA DRIVE, AURORA, ON, L4G-7K1, CA

(73) Assignee: MAGNA INTERNATIONAL INC., Aurora, ON (CA)

(21) Appl. No.: 11/720,549

(22) PCT Filed: Mar. 16, 2006
(86) PCT No.: PCT/CA06/00390

§ 371 Date: May 31, 2007

Related U.S. Application Data
(60) Provisional application No. 60/661,932, filed on Mar. 16, 2005.

(51) Int. Cl. B60G 21/05; B60B 35/02; B62D 65/12; B21D 17/04; B21K 1/06; B23P 11/00

(52) U.S. Cl. 280/124.166; 29/428

(57) ABSTRACT

A traditional twist beam axle found in a vehicle includes a twist beam with a separate torsion beam or a hollow tube formed into an inverted U shape that acts as both the twist beam and the torsion beam. Both solutions are expensive to manufacture A twist beam axle (14) is provided wherein the torsion member (42) is rigidly secured to the twist beam (40) The twist beam (40) has a U-shaped cross-sectional configuration having a bight portion (44) with first (50) and second (52) projections extending therefrom Embodiments include the cross-sectional configuration having an open cavity and the bight portion (44) having an indentation into the open cavity and forming a depression that is covered by the torsion member (42) A method of forming the disclosed twist beam axle (14) is also provided, the method including the step of rigidly securing the torsion member (42) to the bight portion (44) of the twist beam (40)

### FIELD OF THE INVENTION

The present invention relates to twist beams. More specifically, the present application illustrates embodiments of the present invention, including embodiments relating to a vehicle twist beam axle.

### BACKGROUND OF THE INVENTION

U.S. Pat. Nos. 6,616,157 to Christophliemke et al.; 6,401,319 to Hicks et al.; 5,520,407 to Alatalo et al.; 5,518,265 to Buthala et al.; 5,409,254 to Minor et al.; and 5,246,248 to Ferguson et al. each disclose a vehicle rear suspension apparatus. The rear suspension apparatus commonly includes a cross beam that includes a twist beam and a separate torsion beam to provide bending and torsional stiffness. Known twist beams with separate torsion bars are relatively expensive and the shear center of such twist beams is relatively low.

In other twist beams, such as described in U.S. Pat. Nos. 5,324,073 to Alatalo et al.; 5,409,255 to Alatalo et al; 5,518,265 to Buthala et al.; 5,520,407 to Alatalo et al.; 6,059,314 to Streubel et al.; 6,119,501 to Hansen et al.; 6,145,271 to Kössmeier et al.; 6,523,841 to Gläser et al.; 6,616,157 to Christophliemke et al.; 6,708,994 to Etzold; 6,758,921 to Streubel et al.; 6,829,826 to Herzig; and U.S. Patent Publication no. US020020117890A1, a hollow tube is formed into an inverted U shape and acts as the transverse support of the suspension apparatus. These twist beams avoids the use of a twist beam and a separate torsion beam. However, these twist beams are relatively expensive to manufacture.

### SUMMARY OF THE INVENTION

One aspect of the invention relates to a twist beam axle assembly. The assembly has a twist beam having an inverted U-Shaped cross section and a torsion member attached to the twist beam along a bight portion thereof.

Another aspect of the invention relates to a twist beam axle assembly having an open twist beam and a torsion member or cap coupled thereto. The twist beam has a longitudinal axis and an open, cross-sectional configuration transverse to the longitudinal axis. The cross-sectional configuration has a bight portion, a first projection extending from a first edge of the bight portion and a second projection extending from a second edge of the bight portion. The cross-sectional configuration defines an open cavity extending between the first and second projections. The bight portion has an inner surface partially defining the open cavity and an outer surface being opposite to the inner surface. The torsion member is rigidly secured to the bight portion adjacent the outer surface of the bight portion. The torsion member is a separately-formed member with respect to the first member and is attached to the first member. A first arm is coupled to a first end portion of the twist beam and has a wheel hub attaching member. A second arm is coupled to a second end of the twist beam and has a second wheel hub attaching member.

Another aspect of the invention is a method of forming a twist beam axle assembly, comprising: forming a twist beam having a longitudinal axis and an open, cross-sectional configuration transverse to the longitudinal axis, the cross-sectional configuration having a bight portion, a first projection extending from a first end of the bight portion and a second projection extending from a second end of the bight portion, the cross-sectional configuration having an open cavity extending between the first and second projections and being defined by the first projection, the second projection, and the bight portion, the bight portion having an inner surface partially defining the open cavity and an outer surface being opposite to the inner surface; forming a torsion member; rigidly securing the torsion member to the bight portion of the first portion adjacent the outer surface of the bight portion, the first portion and the torsion member forming a twist beam; attaching a first arm to a first end portion of the twist beam; attaching a second arm to a second end portion of the twist beam; attaching a first wheel hub to the first arm; and attaching a second wheel hub to the second arm.

Another aspect of the invention is a method of forming a twist beam axle assembly. A twist beam is roll formed to have an inverted U-shape configuration in cross section, having a bight portion, a first projection or leg extending from a first edge of the bight portion and a second projection or leg extending from a second edge of the bight portion. A torsion member is attached to the bight portion as the twist beam is roll formed. Preferably, the torsion member is seam welded to the twist beam enabling the entire interface between the torsion member and the twist beam to be integrally connected.

Other aspects, features, and advantages of this invention will become apparent from the following detailed description when taken in conjunction with the accompanying drawings, which are a part of this disclosure and which illustrate, by way of example, the principles of this invention.

### BRIEF DESCRIPTION OF THE DRAWINGS

The accompanying drawings facilitate an understanding of the various embodiments of this invention. In such drawings:

FIG. 1 illustrates a vehicle suspension apparatus in accordance to one illustrated embodiment of the present invention;

FIG. 2 illustrates the twist beam illustrated in FIG. 1;

FIG. 3 illustrates the torsion member illustrated in FIG. 1;

FIG. 4 illustrates the twist beam illustrated in FIG. 1;

FIG. 5 illustrates a cross-sectional view of the twist beam of FIG. 1 taken along line 5-5 in FIG. 4;

FIG. 6 illustrates a twist beam in accordance of another embodiment of the invention;

FIG. 7 illustrates a cross-sectional view of the twist beam of FIG. 6 taken along line 7-7 in FIG. 6;

FIG. 8 illustrates a cross-sectional view similar to the view seen in FIG. 5 but of a twist beam in accordance with another embodiment of the present invention;

FIG. 9 illustrates a cross-sectional view similar to the view seen in FIG. 5 but of a twist beam in accordance with yet another embodiment of the present invention; and

FIG. 10 illustrates a cross-sectional view of twist beam in accordance with another embodiment of the invention.

### DESCRIPTION OF ILLUSTRATED EMBODIMENTS

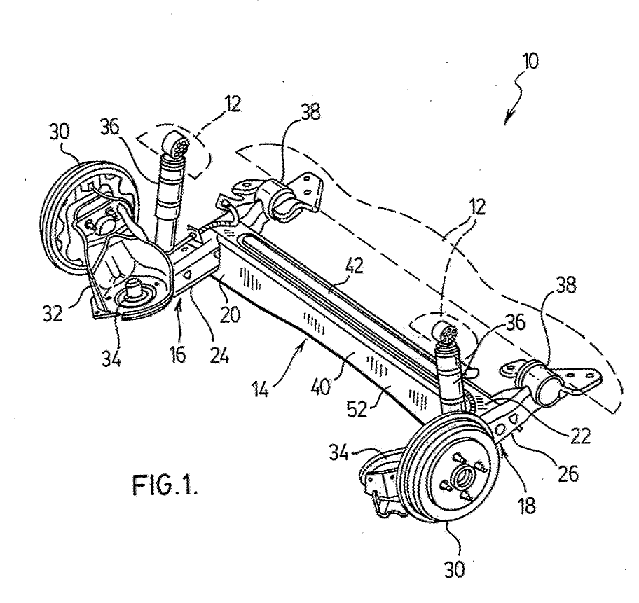

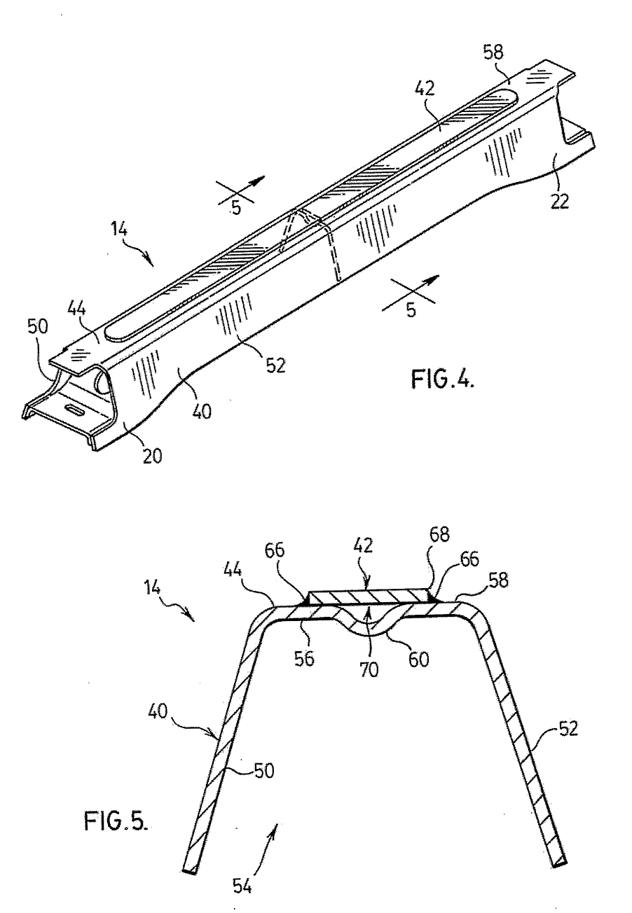

FIGS. 1-5 illustrate one embodiment of the present invention. FIG. 1 illustrates a twist beam rear axle assembly 10 of a motor vehicle. As seen in dashed lines, the assembly 10 is attached to a space frame 12 of the motor vehicle as generally known in the art.

Assembly 10 basically includes a twist beam 14 and two side arm assemblies 16 and 18. The twist beam 14 extends between the side arm assemblies 16 and 18 with a side arm assemblies 16 and 18 coupled to respective ends 20 and 22 of the twist beam 14. Each side arm assembly 16 and 18 includes a side arm 24 and 26, respectively, which is directly attached to the twist beam 14. The remaining illustrated parts for each of the side arm assemblies 16 and 18 are substantially identical for each side arm assembly 16 and 18. That is, each side arm assembly 16 and 18 includes, among other things, a wheel hub 30 and wheel hub mount 32, a spring seat 34, a shock absorber 36 and a bushing connection 38. Each side arm assembly 16 and 18 is attached to the space frame 12, including by an attachment via the shock absorber 36 and the bushing connection 38.

The side arm assemblies 16 and 18, except for their connection to twist beam 14 can be substantially as those known in the art. Twist beams as generally known in the art often contain a twist beam and a separate torsion beam to provide bending and torsional stiffness. However, the embodiments of the subject application illustrate a twist beam 40 with an integral torsion member 42 to provide a cost effective way for providing a twist beam axle with sufficiently high bending stiffness and sufficiently moderate torsional stiffness. Additionally, through the use of an integral torsion member 42, the integral twist beam 14 of the subject application provides for a raised shear center of the twist beam relative to the shear center of a twist beam utilizing a separate torsion bar. Further, the integral twist beam 14 allows for a cost effective method of tailoring the roll rate of a twist axle.

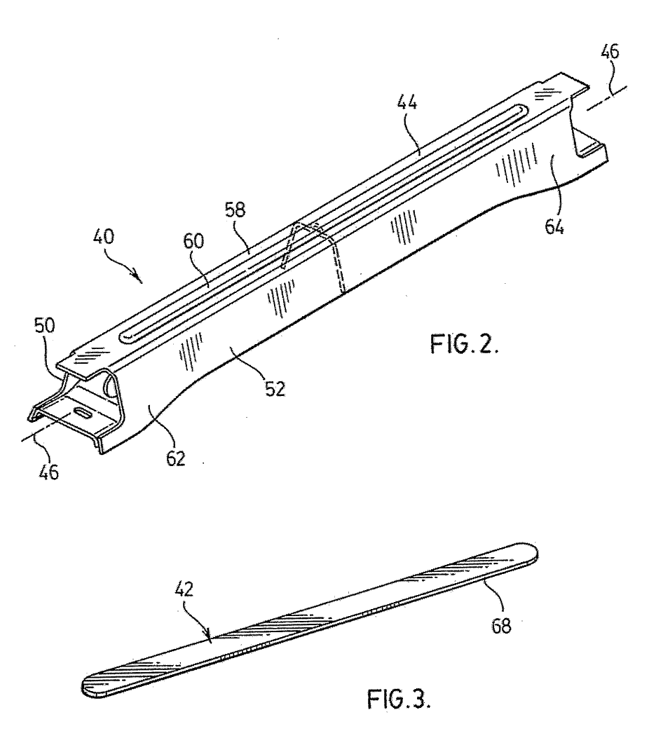

As best seen in FIGS. 2-5, the twist beam 14 includes the twist beam 40 and the torsion member 42 rigidly secured thereto. The twist beam 40 can take various configurations but is illustrated as having a generally, a longitudinal extent with an inverted U-shaped configuration in cross-section, as seen in FIG. 5. Twist beam has a longitudinal axis 46 and the U-shaped cross-section is taken transverse to the longitudinal axis 46. The cross-sectional configuration of twist beam 40 shows the twist beam 40 as having a midspan or bight portion 44, a first projection 50 extending from a first edge of the bight portion and a second projection 52 extending from a second edge of the bight portion 44. The inverted U-shaped cross-sectional configuration defines an open cavity 54 extending between the first and second projections 50 and 52. The bight portion 44, in one embodiment, has an indentation or groove 60 that extends along a substantial length of the twist beam 40, which groove 60 projects into the open cavity 54 and, thus, forms a stiffening rib along the top of the twist beam 40, at the bight portion 44. The indentation 60 forms a depression in the outer surface 58 of the bight portion 44.

Of course, if the twist beam is sufficiently rigid without a stiffening rib, indentation 60 may be omitted, as shown in FIG. 10. Twist beam 40′ has a bight portion 44′ that is generally planar, a first projection or leg 50′ extending from a first edge of the bight portion and a second projection or leg 52′ extending from a second edge of the bight portion 44. The inverted U-shaped cross-sectional configuration defines an open cavity 54 extending between the first and second projections 50′ and 52′. Preferably, the twist beam 40′ is roll formed and the top piece or torsion member 42 is seam welded 66′ to the twist beam 40′ during the roll form process. The preferred welding process is Resistance Seam Welding (RSEW). In utilizing RSEW, the entire interface between the torsion member 42 and the twist beam 40′ is welded.

The twist beam 40 can be made of a variety of appropriate materials and made in a variety of appropriate ways. For example, twist beam 40 may be stamped, roll formed, or extruded and may be made of, for example, steel or aluminum. Twist beam 40 has a first end 62 that is configured for attaching to side arm 24. Twist beam 40 also has a second end 64 that is configured for attaching to side arm 26.

Torsion member 42 may also be made of a variety of appropriate materials and made in a variety of appropriate ways. For example, torsion member 42 may be stamped, roll formed, or extruded and may be made of an appropriate material such as steel or aluminum. Of course, the type of material of the torsion member 42 may depend upon the type of material used for twist beam 40. Twist beam 40 and torsion member 42 may be formed, shaped, and configured as necessary to produce the desired bending stiffness and torsional stiffness properties needed in the twist beam axle.

As seen in FIG. 5, the torsion member 42 is rigidly attached to the outer surface 58 of the bight portion 44 of twist beam 40. As illustrated, the torsion member 42 may be attached by beads 66 of welding material on opposite sides of the indentation 60 such that the torsion member or bar 42 is rigidly secured to the bight portion 44 adjacent the outer surface 58 of the bight portion 44 and extending over the depression 60 in the outer surface 58. Thus, as seen in FIG. 5, the torsion bar 42 and the indentation 60 form a hollow channel 70. The bead 66 of welding may extend along the entire perimeter 68 of the torsion bar 42 or may be selectively located along the perimeter 68 of the torsion bar 42, as necessary. Although welding is illustrated, other types and method of fastening the torsion bar 42 to the twist beam 40 may be employed instead of or in combination with the welding beads 66.

The ability to separately manufacture the twist beam 40 and the torsion member 42 and then subsequently, rigidly attach the two to form an integral twist beam and torsion member provides flexibility and efficiencies in the manufacturing of twist beam axles. For example, it provides the ability to have stocks of various types of twist beams 40 and torsion members 42 that that may be made integral with each other and provide selective bending stiffness and torsional stiffness characteristics in a twist beam 14. In particular, two different motor vehicles may employ the same, basic twist beam 40, but may have different torsional members 42 so that even though both vehicles use the same twist beam, they employ different torsional members and they provide different levels of, for example, roll rate or torsional stiffness since a different torsion member is used.

As mentioned, by altering the specifics of the twist beam 40 and the torsion member 42, such as; shape, thickness, configuration, material, and connection, the twist beam 14 can be tailored for specific applications to produce desired bending stiffness and torsional stiffness. Further, the entire twist beam 14 may be produced by extruding the twist beam 40 and the torsion member 42 as a one-piece, unitary and integrally formed member.

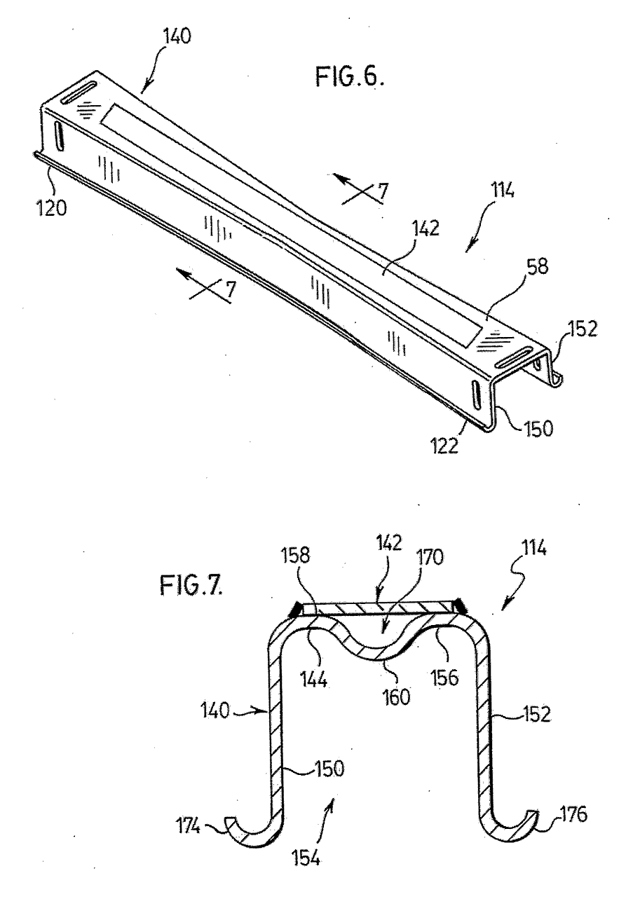

FIGS. 6-8 illustrate another embodiment of the present invention. In particular, the figures illustrate one of the numerous, different configurations that the twist beam may employ. For example, FIG. 6 illustrates a twist beam 114 having a twist beam 140 and a torsion member 142 rigidly attached to the twist beam 140. The twist beam 114 may be substantially identical to twist beam 14 described above except that the twist beam 140 and the torsion member 142 have different shapes, dimensions and configurations.

The cross-sectional configuration of twist beam 140 in FIGS. 6-8 shows the twist beam 140 as having a bight portion 144, a first projection 150 extending from a first end of the bight portion 144 and a second projection 152 extending from a second end of the bight portion 144. The cross-sectional configuration illustrates how the twist beam 140 has an open cavity 154 extending between the first and second projections 150 and 152. The open cavity 154 is defined by the first projection 150, the second projection 152, and the bight portion 144. The bight portion 144 has an inner surface 156 partially defining the open cavity 154 and an outer surface 158 opposite to the inner surface 156. The bight portion 144 has an indentation 160 that extends along a substantial length of the twist beam 140, which projects into the open cavity 154 and, thus, forms a stiffening rib along the top of the twist beam 140, at the bight portion 144. The indentation 160 forms a depression in the outer surface 158 of the bight portion 144. Also, projection 150 has an outwardly curved section 174 and projection 152 has an outwardly curved section 176. Thus, it can be seen that the cross-section of twist beam 140 differs from that of twist beam 40 in that the twist beam 140 has projections 150 and 152 that are substantially perpendicular to sections of the bight portion 144 while the projections 50 and 52 in twist beam 40 are outwardly flared with respect to bight portion 44. Also, the indentation 160 is deeper and wider than the indentation 60 and whereas the projections 50 and 52 are substantially straight in twist beam 40, the projections 150 and 152 have outwardly curved sections 174 and 176, respectively, in twist beam 140. Therefore, the torsional bending and stiffness bending of twist member 114 will differ from that of twist member 14 while still employing a torsion bar 142 that is integrally attached to the twist beam 140 along substantial parts of the length of the twist beam 140. Twist beam 114 may be employed in otherwise conventional twist beam rear axle assemblies.

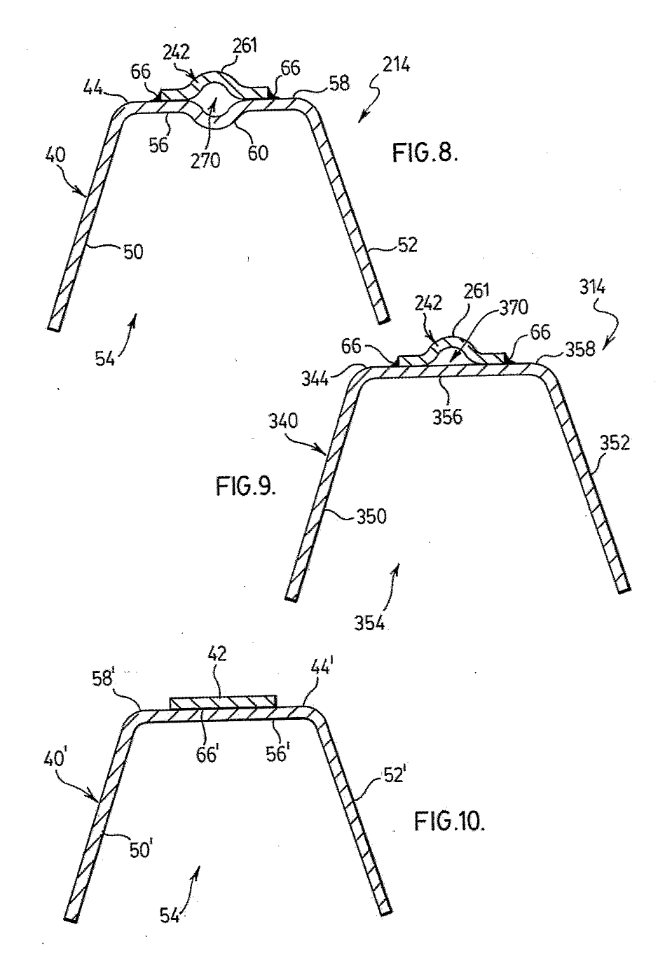

FIGS. 8 and 9 illustrate additional embodiments of the twist beam in accordance with the subject invention. In particular, FIG. 8 illustrates the cross-sectional configuration of a twist beam 214 having twist beam 40 that is substantially identical to twist beam 40 described above with respect to the embodiment illustrated in FIG. 5. The embodiment of FIG. 8 differs from the embodiment of FIG. 5 in that the embodiment of FIG. 8 employs a different torsion member. That is, the embodiment of FIG. 8 illustrates torsion member 242, which is substantially identical to torsion bar 42 described above except that torsion bar 242 includes an indentation 261 that is positioned opposite to indentation 60 to form a hollow channel 270 between twist beam 40 and torsion member 242 that is larger than the hollow channel 70 above. Additionally, the indentation 261 may mirror indentation 61 and run substantially the entire length of torsion member 242 to form a rib in member 242. Thus, the stiffness of the torsion member 242 is increased relative to a substantially flat torsion member such as member 42. This provides yet another example of providing a desired level of torsional stiffness to a twist beam to permit use of the twist beam with a separate, nonintegral torsion bar.

The embodiment of FIG. 9 illustrates a twist beam 314 that is substantially identical to that of FIG. 8, except for the removal of the indentation in the bight portion of the twist beam. That is, twist beam 34 has a bight portion 344 that is substantially flat. Twist beam still has a first projection 350 extending from a first end of the bight portion 344 and a second projection 352 extending from a second end of the bight portion 344. The cross-sectional configuration illustrates how the twist beam 340 has an open cavity 354 extending between the first and second projections 350 and 352. The open cavity 354 is defined by the first projection 350, the second projection 352, and the bight portion 344. The bight portion 344 has a substantially flat inner surface 356 partially defining the open cavity 354 and a substantially flat outer surface 358 opposite to the inner surface 356. The bight portion 344 does not have an indentation that extends along a substantial length of the twist beam and, instead, is substantially flat along substantially its entire length. However, torsion member 242 in FIG. 9 is substantially identical to torsion member 242 used in the embodiment of FIG. 8 and includes an indentation 261 that is positioned to form a hollow channel 370 between twist beam 340 and torsion member 242. Additionally, the indentation 261 may run substantially the entire length of torsion member 242 to form a rib in member 242. This provides yet another example of providing a desired level of torsional stiffness to a twist beam to permit use of the twist beam with a separate, nonintegral torsion bar.

Among other things, the embodiments illustrate various ways to create a stiffened bight portion, for example by a small closed cavity section or hollow channel such as 70, 170, 270, 370, together with a larger open section such as 54, 154, 354. This ability to have a smaller closed section and a larger open section can increase the torsional constant of the section enough so that a separate torsion bar is not needed, while, not increasing the torsional constant so high that the twist beam will fail in normal use.

In the following table, the relative characteristics of the twist beams of the present invention are listed:

| | 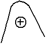 | 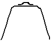 | 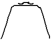 | 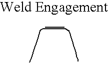 |
|---|---|---|---|---|
| | Baseline- | Integral- | Integral- | Flat Cap- |
| | 4.8 mm | 4.0 mm | 4.8 mm | 4.8 mm |
| I_{XX} | 1791000 | 937000 | 1633000 | 1683000 |
| I_{YY} | 864000 | 604000 | 731000 | 744000 |
| Torsional | 14859 | 13903 | 14064. | 13952 |
| Constant | | | | |
| Area | 1312 | 1068 | 1168 | 1176 |

It is apparent from this Table that the beam stiffness can be tailored to specific requirements and specifications while utilizing a common twist beam and modifying or selecting a different torsion beam and/or method of securement and/or the amount of contact interface between the twist beam and the torsion beam.

In the above example, a torsion constant of approximately the same order of magnitude can be achieved by several methods. The baseline torsional constant is 14859. The present invention can achieve a torsional constant by several methods. In the first example, the torsion beam thickness is 4.0 mm with a longitudinal groove that forms a hollow channel on the bight portion. In the next example, the torsion beam thickness if 4.8 mm with a relatively smaller longitudinal groove, and hence greater contact interface between the torsion beam and the twist beam. In the last example, the torsion beam thickness is 4.8 mm and seam welded to the twist beam. In all three examples, the torsion constant is relatively equivalent.

The foregoing specific embodiments have been provided to illustrate the structural and functional principles of the present invention, and are not intended to be limiting. To the contrary, the present invention is intended to encompass all modifications, alterations, and substitutions within the scope of the appended claims.

What is claimed is:

1. A twist beam axle comprising:
a twist beam having an inverted U-shaped cross-sectional configuration and a longitudinal extent, said cross-sectional configuration having a bight portion, and
a torsion member rigidly secured to said bight portion.

2. A twist beam axle according to claim 2, wherein said torsion member is welded to said twist beam.

3. A twist beam axle according to claim 2 wherein said torsion member is seam welded to said twist beam.

4. A twist beam axle according to claim 3, wherein said torsion member extends substantially along said bight portion.

5. A twist beam axle according to claim 4, wherein said twist beam has a longitudinally extending groove and said torsion member closes said groove defining a hollow channel.

6. A twist beam axle according to claim 4, wherein said twist beam has a longitudinally extending groove and said torsion member has a longitudinally extending groove and said torsion member closes said grooves defining a hollow channel.

7. A twist beam axle according to claim 4, wherein said torsion member has a longitudinally extending groove and said bight portion closes said groove defining a hollow channel.

8. A twist beam axle according to claim 4, wherein said twist beam has a first projection and a second projection extending from opposite side edges of said bight section defining said inverted U-shaped cross-sectional configuration and each of said first and second projections is curved.

9. A twist beam axle according to claim 1, wherein said torsion member is separately formed member with respect to said twist beam.

10. A twist beam axle according to claim 1, further comprising:
a first arm coupled to a first end of said twist beam, said first arm having a wheel hub attaching member; and
a second arm coupled to a second end of said twist beam, said second arm having a second wheel hub attaching member.

11. A method of forming a twist beam axle assembly, comprising:
forming an elongate twist beam having an inverted U-shaped cross-sectional configuration defining an open section;
forming an elongate torsion beam; and
rigidly securing the torsion beam to a bight portion of the twist beam.

12. A method according to claim 11, wherein the step of rigidly securing the torsion member to the bight portion includes welding the torsion member to the bight portion.

13. A method according to claim 12, wherein the step of forming the twist beam includes forming a groove in the bight portion that projects into the open section, and the step of rigidly securing the torsion beam including positioning the torsion beam to extend over the groove.

14. A method according to claim 13, wherein the step of forming the torsion beam includes forming a torsion beam groove, and the step of rigidly securing the torsion beam including positioning the torsion beam groove to extend over the twist beam groove.

15. A method according to claim 13, wherein the step of forming the torsion beam includes forming a torsion beam groove, and the step of rigidly securing the torsion beam including positioning the torsion beam groove to extend over the twist beam.

16. A method according to claim 12, wherein the step of forming the elongate twist beam is roll forming.

17. A method according to claim 16, wherein the torsion member is welded during the roll forming step.

18. A method according to claim 17, wherein the welding is seam welding.

19. A method according to claim 18, wherein the seam welding is resistance seam welding.

20. A method according to claim 12, wherein the torsion beam is rigidly secured to the twist beam along an interface therebetween.

21. A method according to claim 20, wherein the torsion beam is rigidly secured to the twist beam by resistance seam welding.
